(19) United States
(12) Patent Application Publication
(10) Pub. No.: US 2021/0099623 A1
(43) Pub. Date: Apr. 1, 2021

(54) IMAGE PICKUP APPARATUS

(71) Applicant: CANON KABUSHIKI KAISHA, Tokyo (JP)

(72) Inventor: Yuki Oyama, Kanagawa (JP)

(21) Appl. No.: 17/119,439

(22) Filed: Dec. 11, 2020

Related U.S. Application Data
(63) Continuation of application No. PCT/JP2019/024180, filed on Jun. 19, 2019.

(30) Foreign Application Priority Data
Jun. 28, 2018 (JP) 2018-122944
May 14, 2019 (JP) 2019-091387

(51) Int. Cl. H04N 5/225; G03B 17/12; G03B 11/00

(52) U.S. Cl. CPC H04N 5/2254; H04N 5/2253; G03B 11/00; G03B 17/12

(57) ABSTRACT

An image pickup apparatus includes an image sensor, a sensor holding member holding the image sensor, a driving member that rotates the sensor holding member about a rotation axis so as to be tilted with respect to a plane perpendicular to the optical axis of an image capturing lens, and an optical filter that can be inserted and removed on the optical axis of the image capturing lens. A direction in which the optical filter is inserted and removed is substantially parallel to a direction in which the rotation axis extends.

### CROSS-REFERENCE TO RELATED APPLICATIONS

This application is a Continuation of International Patent Application No. PCT/JP2019/024180, filed Jun. 19, 2019, which claims the benefit of Japanese Patent Application No. 2018-122944, filed Jun. 28, 2018 and No. 2019-091387, filed May 14, 2019, all of which are hereby incorporated by reference herein in their entirety.

### BACKGROUND OF THE INVENTION

### Field of the Invention

The present invention relates to image pickup apparatuses, such as a surveillance camera.

### Background Art

In surveillance cameras, such as a network camera, the camera unit can capture an image by forming an image of incident light passing through the lens unit with an image sensor.

In general, a captured image of the subject in the depth of field has high imaging quality, and a captured image of the subject out of the depth of field has degraded imaging quality.

In particular, using an open aperture tends to cause an imaging area outside the depth of field. This causes, for surveillance application, an area in which the subject, for example, the face of a criminal, is poorly imaged in the screen, so that the subject cannot be recognized.

In such a case, a plurality of surveillance cameras may be installed according to the distance to the subject so that the subject is present in the depth of field. This however increases the number of cameras, and it is preferable to use a single camera with a large depth of field.

For night surveillance, the aperture is sometimes opened to take in a large amount of light. For this reason, recognition of the subject, with the aperture opened, may be important.

Known techniques for increasing the depth of field with the aperture opened include a technique of cameras with a tilt-shift function for tilting the lens and the image sensor relative to each other to increase the depth of field.

Many surveillance cameras are provided with an optical filter for blocking infrared light to capture a good image in light daylight. Common optical filters are detachable, and in night or dark site surveillance that requires a large amount of light, are retracted to also take in light in the infrared range. The optical filter is normally disposed in the vicinity of the image sensor.

PTL 1 discloses an image pickup apparatus including a tilt-shift adjusting mechanism for adjusting the tilt-shift angle and an optical-filter insertion and extraction mechanism movable in the direction perpendicular to the optical axis and including an infrared cut filter and a dummy glass plate.

However, both of the tilt-shift mechanism for the image sensor and the optical-filter insertion and extraction mechanism require a fixed moving space in the optical axis. For this reason, the technique described in Japanese Patent No. 5499581 needs separate spaces for the tilt-shift mechanism and the optical-filter insertion and extraction mechanism, which can increase the size of the image pickup apparatus.

### CITATION LIST

### Patent Literature

PTL 1: Japanese Patent No. 5499581

### SUMMARY OF THE INVENTION

The present invention provides an image pickup apparatus in which both of the image-sensor tilt-shift mechanism and the optical-filter insertion and extraction mechanism can be mounted without increasing the size.

To solve the above problem, an aspect of an image pickup apparatus according to the present invention includes an image sensor, a sensor holding member holding the image sensor, a driving member that rotates the sensor holding member about a rotation axis so as to be tilted with respect to a plane perpendicular to the optical axis of an image capturing lens, and an optical filter that can be inserted and removed on the optical axis of the image capturing lens, wherein a direction in which the optical filter is inserted and removed is substantially parallel to a direction in which the rotation axis extends.

Further features of the present invention will become apparent from the following description of exemplary embodiments with reference to the attached drawings.

### BRIEF DESCRIPTION OF THE DRAWINGS

FIG. 1 is an external perspective view of a surveillance camera of the present embodiment.

FIG. 2 is an exploded perspective view of an image pickup apparatus of the present embodiment.

FIG. 3A is a diagram illustrating a state in which a sensor holding frame is tilted in the present embodiment.

FIG. 3B is a diagram illustrating a state in which the sensor holding frame is tilted in the present embodiment.

FIG. 4 is a diagram illustrating a state in which optical filters are changed in the present embodiment.

FIG. 5A is a side view of the periphery of the optical filters in the present embodiment.

FIG. 5B is a side view of the periphery of the optical filters in the present embodiment.

FIG. 6 is a perspective view of the periphery of the optical filters in the present embodiment.

### DESCRIPTION OF THE EMBODIMENTS

A preferable embodiment of the present invention will be described hereinbelow with reference to the attached drawings.

(Schematic Configuration of Surveillance Camera)

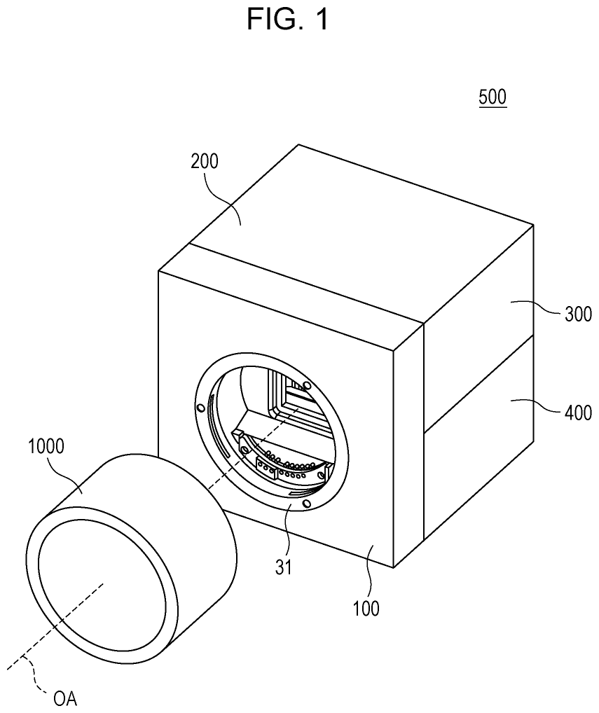

Referring first to FIG. 1, the configuration of a surveillance camera 500 will be described. FIG. 1 is an external perspective view of the surveillance camera 500 of the present embodiment.

The surveillance camera 500 includes a camera main body (an image pickup apparatus) 200 and a lens unit (a lens barrel) 1000 that is detachable from the camera main body 200. The camera main body 200 and the lens unit 1000 may be integral with each other. The camera main body 200 includes an image sensor unit 600 including an image sensor and a substrate for image capturing.

The lens unit 1000 includes an imaging optical system, such as a fixed lens, a zoom lens, and a focus lens. The fixed lens is fixed in the direction along an optical axis OA (an optical axis direction). The zoom lens is moved in the optical axis direction by a zoom driving unit to perform a scaling operation (zooming). The focus lens is moved in the optical axis direction by a focus driving unit to perform a focusing operation (focusing). The light that has passed through the imaging optical system of the lens unit 1000 is imaged by the image sensor.

The camera main body 200 includes a base member 100, the image sensor unit 600, an optical filter unit 700, an upper case 300, and a bottom case 400. As illustrated in FIG. 1, the base member 100 includes a mount portion 31 serving as an attaching portion for attaching the lens unit 1000. The mount portion 31 has a what-is-called bayonet structure including three claws that engage with the claws of the lens unit 1000 for securing.

(Configuration of Image Sensor Unit 600)

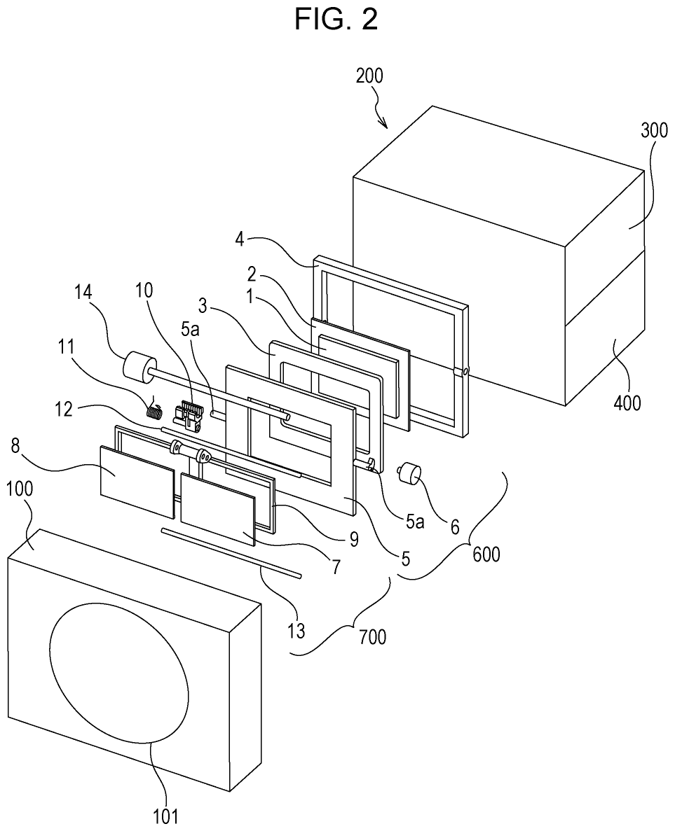

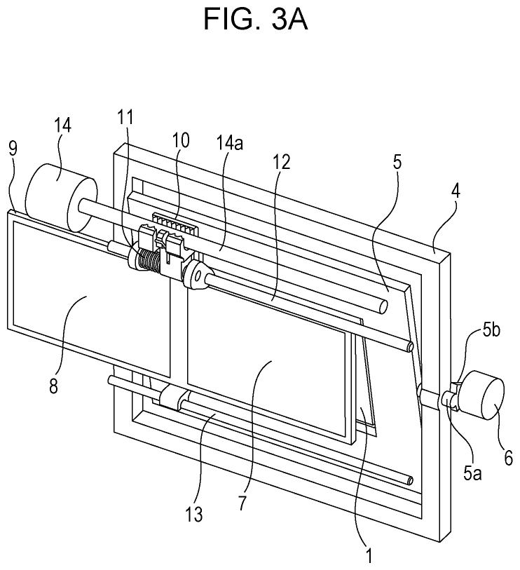

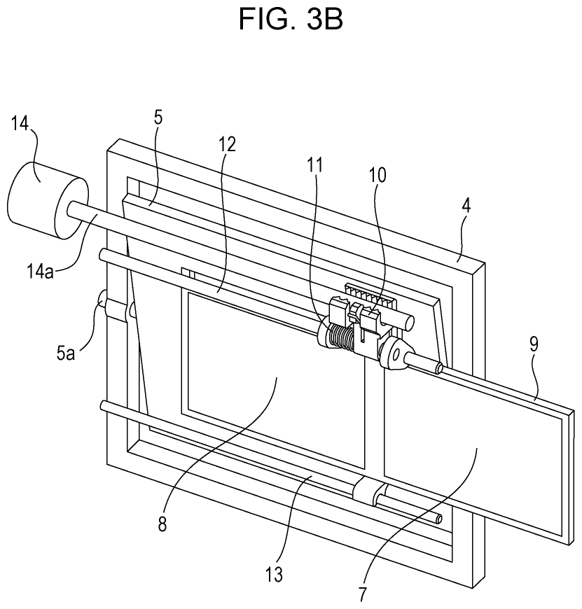

Referring next to FIGS. 2 and 3, the configuration of the image sensor unit 600 will be described. FIG. 2 is an exploded perspective view of the camera main body 200. FIGS. 3A and 3B are diagrams illustrating a sensor holding frame 5 being tilting. FIG. 3A illustrates a state in which the upper part of the sensor holding frame 5 is tilted toward the subject. FIG. 3B illustrates a state in which the lower part of the sensor holding frame 5 is tilted toward the subject.

An image sensor 1 includes a complementary metal-oxide semiconductor (CMOS) sensor and a charge-coupled device (CCD) sensor and photoelectrically converts a subject image (an optical image) formed via the imaging optical system of the lens unit 1000 to output an electrical signal (image data). The image sensor 1 is soldered to an image sensor substrate 2 and is attached to a sensor plate 3 with an adhesive (not illustrated). The image sensor substrate 2 is connected to a control substrate (not illustrated) with a cable (not illustrated). The sensor plate 3 to which the image sensor 1 and the image sensor substrate 2 are attached is fixed to the sensor holding frame 5, which is a sensor holding member, with fastening screws. The sensor holding frame 5 is integral with a tilt shaft 5a serving as a rotation shaft on the substantially imaging place of the image sensor 1. The tilt shaft 5a is held so as to be tilted with respect to the tilt base 4. The tilt base 4 is a member that rotatably holds the sensor holding frame 5 and is held by the upper case 300 and the bottom case 400.

A gear 5b is formed on the tilt shaft 5a and engages with a motor 6 serving as a driving member. The motor 6 transmits a driving force to the gear 5b to tilt the sensor holding frame 5 with respect to the tilt base 4. The tilt shaft 5a extends substantially parallel to the longitudinal direction of the image sensor 1. Since the image sensor 1 can be tilted with respect to the image capturing lens via the image sensor substrate 2 and the sensor plate 3 by the rotation of the sensor holding frame 5, imaging of a deep depth of field can be performed.

A washer is disposed between the sensor holding frame 5 and the tilt base 4. A washer and a wave washer are disposed between another sensor holding frame 5 and the tilt base 4. The wave washer urges the sensor holding frame 5 to prevent displacement of the tilt base 4. Urging the sensor holding frame 5 in the direction of the tilt shaft 5a (a rotation axis direction) prevents the displacement of the image sensor due to a change in orientation, the vibration, and so on of the camera main body 200.

(Configuration of Optical Filter Unit 700)

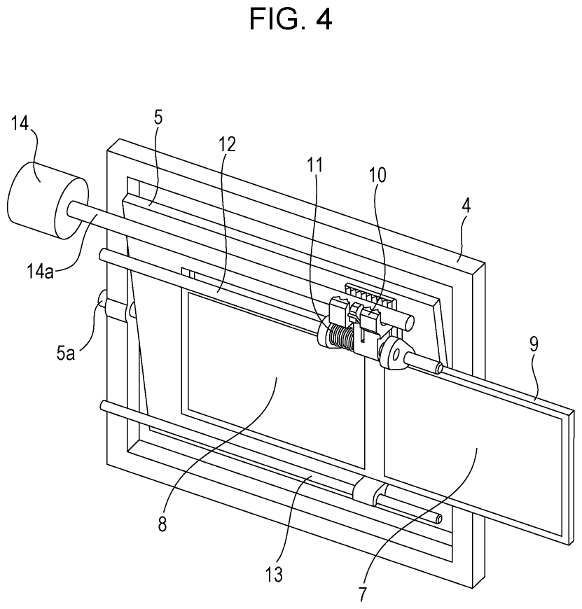

Next, the configuration of the optical filter unit 700 will be described with reference to FIGS. 2, 3, and 4. FIG. 4 is a diagram illustrating a state in which optical filters are changed.

An infrared cut filter 7 is used to cut infrared light. A glass filter 8 is inserted into the optical path in place of the infrared cut filter 7 removed from the optical path to correct the optical path length. Imaging modes include a what-is-called day mode for giving priority to color reproducibility of the subject, in which the infrared cut filter 7 is inserted into the optical path to capture an image to prevent infrared light from entering the image sensor and a what-is-called night mode for imaging in a dark environment which is a low illumination environment, in which the infrared cut filter 7 is removed from the optical path to capture an image, with not only visible light but also infrared light taken into the image sensor, to improve the subject recognition. Inserting and removing the infrared cut filter 7 into and from the optical path allows for switching between day-mode image capturing and night-mode image capturing.

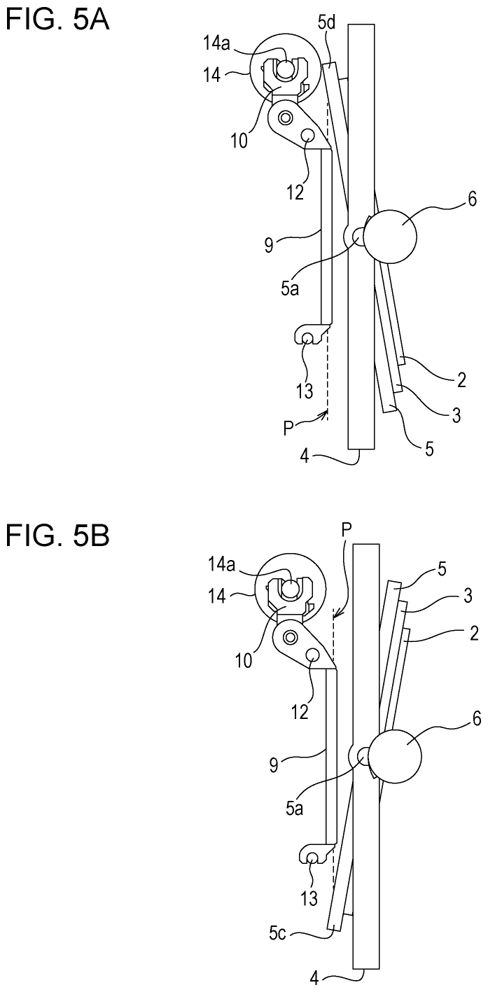

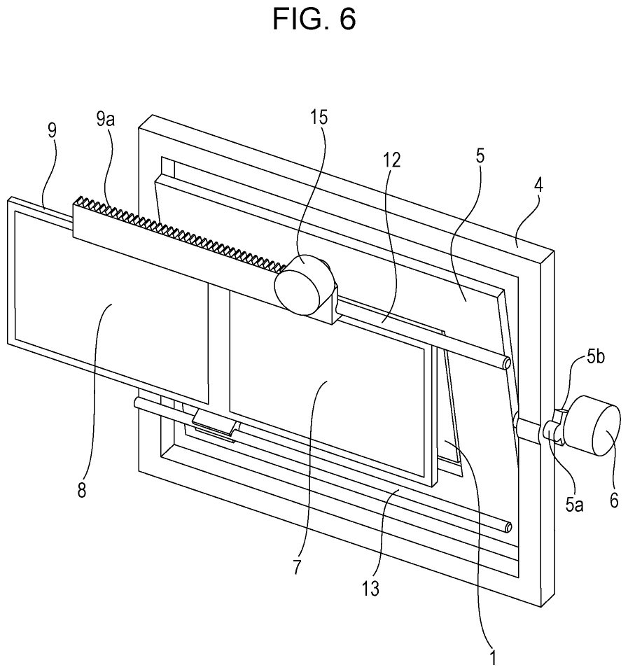

A filter holding frame 9 holds the infrared cut filter 7 and the glass filter 8 and is guided in the direction perpendicular to the optical axis by a guide bar 12 and a rotation control bar 13. The guide bar 12 and the rotation control bar 13 are disposed substantially parallel to the longitudinal direction of the image sensor 1. The guide bar 12 and the rotation control bar 13 are disposed closer to the subject than a plane on which the infrared cut filter 7 and the glass filter 8 move. Specifically, as illustrated in FIG. 5, the guide bar 12 and the rotation control bar 13 are disposed closer to the subject than a plane P on which the infrared cut filter 7 and the glass filter 8 move.

A rack 10 is fixed to the filter holding frame 9 while being urged by a rack spring 11 in the direction perpendicular to the optical axis and in the rotation direction, engages with a screw 14a of a stepping motor 14, and is driven in the direction perpendicular to the optical axis by the rotation of the screw 14a. This allows the filter holding frame 9 to move in the direction perpendicular to the optical axis so as to be inserted and removed into and from the optical axis. The direction in which the infrared cut filter 7 and the glass filter 8 are inserted and removed is substantially parallel to the direction in which the tilt shaft 5a extends.

More specifically, the filter holding frame 9 is moved from the state in which the infrared cut filter 7 is disposed on the optical path, as illustrated in FIG. 2, in the direction perpendicular to the optical axis by the rotation of the screw 14a of the stepping motor 14. Thus, the glass filter 8 is disposed on the optical path, as illustrated in FIG. 3B.

(Details of Image Sensor during Rotation)

Referring next to FIG. 5, the relationship between the optical filter unit 700 and the image sensor unit 600 while the image sensor is rotated will be described.

FIGS. 5A and 5B are side views of the periphery of the optical filters according to the present embodiment. FIG. 5A is a diagram illustrating a state in which the upper part of the sensor holding frame 5 is tilted toward the subject, and FIG. 5B is a diagram illustrating a state in which the lower part of the sensor holding frame 5 is tilted toward the subject.

When the sensor holding frame 5 rotates with respect to the tilt base 4 about the tilt shaft 5a, the upper part or the lower part of the sensor holding frame 5 moves toward the subject from a plane perpendicular to the optical axis. In the state in which the sensor holding frame 5 is rotated to a rotation end (for example, 15 degrees), the infrared cut filter 7 and the glass filter 8 overlap with the sensor holding frame 5 as viewed from the direction perpendicular to both of the optical axis and the direction in which the tilt shaft 5a extends, as illustrated in FIG. 4.

In the case of the configuration in which the filter holding frame 9 is driven in the direction perpendicular to the tilt shaft 5a, as in the conventional example, the above configuration causes the filter holding frame 9 to abut the sensor holding frame 5, depending on the rotation angle of the image sensor 1. This can cause the filter holding frame 9 not to be inserted and removed. This requires a space for the movement of the filter holding frame 9 between the filter holding frame 9 and the sensor holding frame 5.

However, in the present embodiment, the filter holding frame 9 is driven in the direction of the tilt shaft 5a. This eliminates the need for the space for the movement of the filter holding frame 9 between the filter holding frame 9 and the sensor holding frame 5. This allows for disposing the image sensor 1 close to the filter holding frame 9, allowing the tilt-shift mechanism for the image sensor 1 and the optical-filter insertion and extraction mechanism to be mounted without increasing the size of the image pickup apparatus.

The guide bar 12 that guides the filter holding frame 9 and the rotation control bar 13 are disposed closer to the image capturing lens than the plane P in which the infrared cut filter 7 and the glass filter 8 (see FIG. 4) move in the optical axis direction. For this reason, the image pickup apparatus is not increased in size in the direction perpendicular to both of the direction perpendicular to the moving direction of the filter holding frame 9 and the optical axis as compared with a case in which the guide bar 12 and the rotation control bar 13 are disposed on the plane P. This allows for disposing the image sensor 1 closer to the filter holding frame 9.

(Modification)

FIG. 6 is a perspective view of the periphery of the optical filters according to a modification of the present invention. The filter holding frame 9 includes a gear 9a on the top. The gear 9a is substantially parallel to the longitudinal direction of the image sensor 1. A motor 15 engages with the gear 9a and drives the filter holding frame 9 in the longitudinal direction of the image sensor 1. This configuration eliminates the need for a space lateral to the filter holding frame 9 as compared with a case in which the motor 14 is disposed on the side of the filter holding frame 9.

In the present embodiment, the image sensor substrate 2 is held by the sensor holding frame 5 via the sensor plate 3. Alternatively, the image sensor substrate 2 may be held directly by the sensor holding frame 5, without the sensor plate 3.

Having described the preferred embodiments of the present invention, it is to be understood that the present invention is not limited to those embodiments and various modifications and changes can be made within the spirit and the scope thereof.

The image pickup apparatus of the present embodiment can be used to move the image sensor and can be installed in optical devices.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image pickup apparatus comprising:
an image sensor;
a sensor holding member holding the image sensor;
a driving member that rotates the sensor holding member about a rotation axis so as to be tilted with respect to a plane perpendicular to an optical axis of an image capturing lens; and
an optical filter that can be inserted and removed on the optical axis of the image capturing lens,
wherein a direction in which the optical filter is inserted and removed is substantially parallel to a direction in which the rotation axis extends.

2. The image pickup apparatus according to claim 1, wherein in a state in which the sensor holding member is rotated to a rotation end, the optical filter overlaps with the sensor holding member when viewed from a direction perpendicular to both the optical axis and the direction in which the rotation axis extends.

3. The image pickup apparatus according to claim 1, wherein the rotation axis extends in a direction substantially parallel to a longitudinal direction of the image sensor.

4. The image pickup apparatus according to claim 1, further comprising:
a filter holding frame holding the optical filter; and
a guide bar for guiding movement of the filter holding frame,
wherein the guide bar is close to the image capturing lens than a plane in which the optical filter is inserted and removed in the optical axis direction.

5. The image pickup apparatus according to claim 1, wherein the filter holding frame holds an infrared cut filter and a dummy glass.

6. The image pickup apparatus according to claim 5, wherein the infrared cut filter and the dummy glass are disposed next to each other in the rotation axis direction

7. The image pickup apparatus according to claim 1, further comprising an attaching portion to which the image capturing lens can be attached.
